(19) United States
(12) Patent Application Publication
(10) Pub. No.: US 2002/0167480 A1
(43) Pub. Date: Nov. 14, 2002

(54) Electrophoretic color display device

(76) Inventors: Mark Thomas Johnson, Eindhoven (NL); Dirk Kornelis Gerhardus De Boer, Eindhoven (NL)

Correspondence Address: Corporate Patent Counsel, U.S. Philips Corporation, 580 White Plains Road, Tarrytown, NY, 10591, US

(21) Appl. No.: 10/128,638

(22) Filed: Apr. 23, 2002

(30) Foreign Application Priority Data
Apr. 25, 2001 (EP) 01201495.7

(51) Int. Cl. G09G 3/34

(52) U.S. Cl. 345/107

(57) ABSTRACT

In multi-color electrophoretic displays, grey values are realized by introducing a further electrode (6′) in addition to the conventional electrodes (6, 7) for bistable operation. Several embodiments are shown.

The invention relates to an electrophoretic multi-color display device comprising at least a pixel with an electrophoretic medium, and two switching electrodes and drive means via which the pixel can be brought to different optical states. Where a switching electrode is referred to in this application, it may be divided, if desired, into a plurality of sub-electrodes which are supplied with one and the same voltage externally or via switching elements.

Electrophoretic display devices are based on the motion of charged, usually colored particles under the influence of an electric field between two extreme states having a different light transmissivity or light reflectivity. Dark (colored) characters can be imaged on a light (colored) background, and vice versa.

Electrophoretic display devices are therefore notably used in display devices taking over the function of paper, referred to as the “paper white” applications (electronic newspapers, electronic diaries).

In the known electrophoretic display devices with an electrophoretic medium between two switching electrodes, the switching electrodes are supplied with drive voltages. In this case, the pixel can be exclusively brought to two extreme optical states. One of the switching electrodes is then realized, for example, as two mutually interconnected narrow conducting strips on the upper side of a display element. At a positive voltage across this switching electrode with respect to a bottom electrode, which covers the entire bottom surface of the display element, particles (which are negatively charged in this example) move towards the potential plane which is defined by the two interconnected narrow conducting strips. The (negatively) charged particles are then distributed across the front face of the display element (pixel) which then assumes the color of the charged particles. At a negative voltage across the switching electrode with respect to the bottom electrode, the (negatively) charged particles move across the bottom face so that the display element (pixel) assumes the color of the liquid.

In practice, there is an ever increasing need of displaying intermediate optical states (referred to as grey values). Known methods of introducing grey values are usually not satisfactory. For example, electrophoretic display devices are too slow to introduce grey values via time-weighted drive periods (time ratio grey scale). A division of the pixel into different surfaces (area ratio grey scale) usually requires barriers between the different sub-pixels so as to prevent mutual crosstalk.

Moreover, the number of electrodes required for driving strongly increases in multi-color display devices.

It is an object of the present invention to obviate this drawback. In an electrophoretic color display device according to the invention, grey values (intermediate optical states) are realized by providing the pixel with at least one further electrode and drive means for realizing intermediate optical states via electric voltages.

The invention is based on the recognition that the electric field within a display cell can be influenced by means of electric voltages on the further electrode or electrodes in such a way that, in the example described above, the electric field lines are disturbed at a positive voltage across the switching electrode relative to the bottom electrode, such that the negatively charged particles move only partly towards the surface between the two electrodes. Dependent on the electric voltages across the switching electrodes and the further electrode, a larger or smaller number of particles move towards the surface between the two electrodes and different intermediate optical states (grey values) are obtained. The color display device may be provided with, for example, a color filter, but a pixel may also consist of a plurality of separate electrophoretic sub-pixels. In that case, it may be advantageous to form a sub-pixel as a microcapsule as described in, for example, “Micro encapsulated Electrophoretic Materials for Electronic Paper Displays”, 20^{th} IDRC Conference, pp. 84-87 (2000). The microcapsules may also be obtained by creating barriers, for example, polymer walls (for example, Axially Symmetric Aligned Microcells, see SID 898 Digest, pp. 1089).

The invention is further based on the recognition that different intermediate optical states can be obtained for each of the composite colors when using electrophoretic particles with a different mobility and a suitable pulse pattern on the further electrodes. Usually, it is then sufficient to use a smaller number of electrodes. To obtain a satisfactory distribution across the surface between the two electrodes upon a change of the setting, it is preferred to uniformly distribute the charged particles in advance across the other electrode, for example, by bringing the pixel to a defined state prior to selection (for example, by means of a reset pulse), if necessary in combination with a small alternating field component.

In a first embodiment, the electrophoretic medium is present between two substrates which are each provided with a switching electrode, while at least one of the substrates is provided with the further electrode or electrodes. The charged particles may be present in a liquid between the substrates, but it is alternatively possible for the electrophoretic medium to be present in a microcapsule. In the first-mentioned case, the pixels may be mutually separated by a barrier.

In a further embodiment, the electrophoretic medium is present between two substrates, in which one of the substrates comprises the switching electrodes and the further electrode or electrodes, notably when use is made of a lateral effect.

In a preferred embodiment, the switching electrodes are comb-shaped and interdigital and parts of the (insulated) further electrode or electrodes are situated between the teeth of the two switching electrodes. The electrophoretic medium may be alternatively present in a prismatic structure as described in “New Reflective Display Based on Total Internal Reflection in Prismatic Microstructures” Proc. 20^{th} IDRC Conference, pp. 311-314 (2000).

These and other aspects of the invention are apparent from and will be elucidated with reference to the embodiments described hereinafter.

In the drawings:

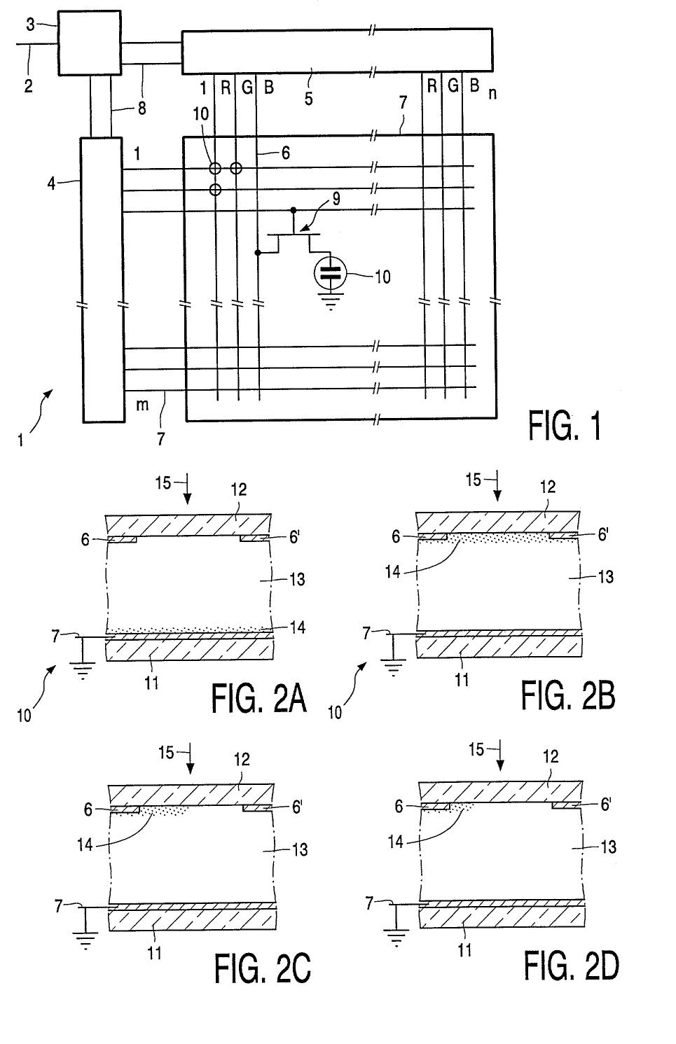

FIG. 1 shows diagrammatically a color display device,

FIG. 2 shows a pixel of an electrophoretic color display device according to the invention, in which different grey values (intermediate optical states) have been realized,

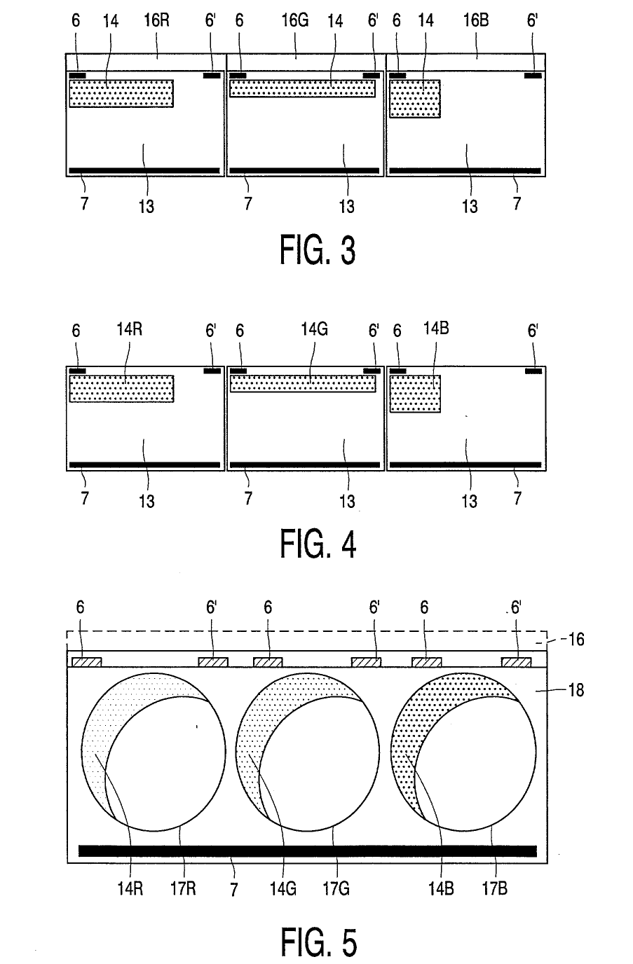

FIG. 3 shows an electrophoretic color display device according to the invention, in which different grey values (intermediate optical states) have been realized,

FIG. 4 shows a variant of FIG. 3,

FIG. 5 shows a further electrophoretic color display device according to the invention, in which different grey values (intermediate optical states) can be realized,

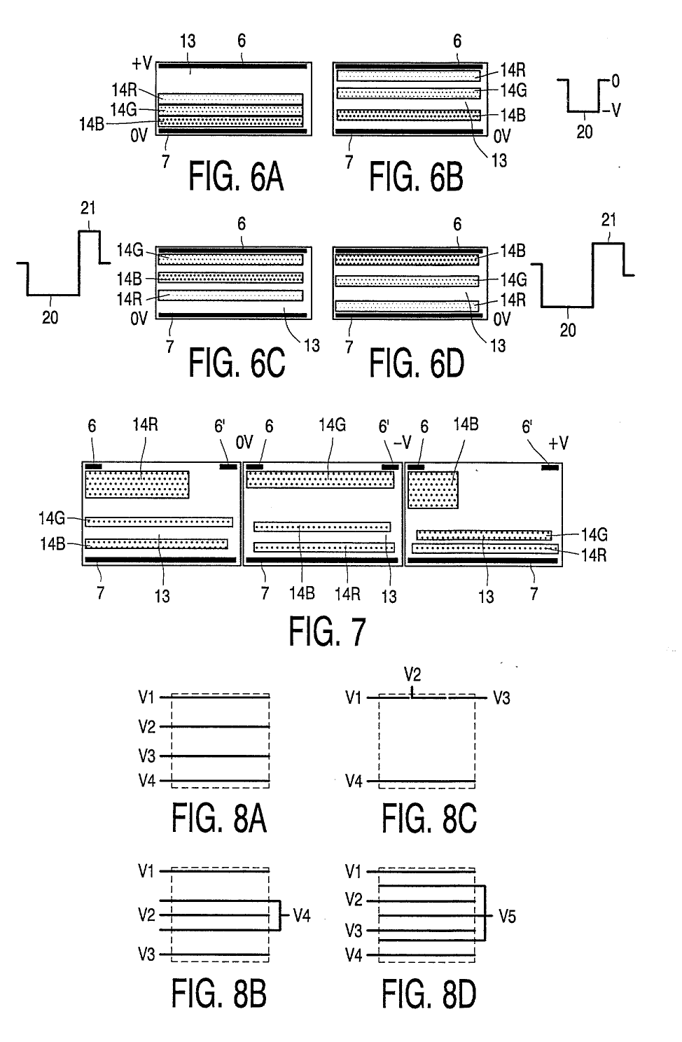

FIG. 6 shows how different colors are realized in a known color display device,

FIG. 7 shows how different grey values can be realized in the color display device of FIG. 6 according to the invention,

FIG. 8 is a plan view of a part of a further electrophoretic color display device according to the invention,

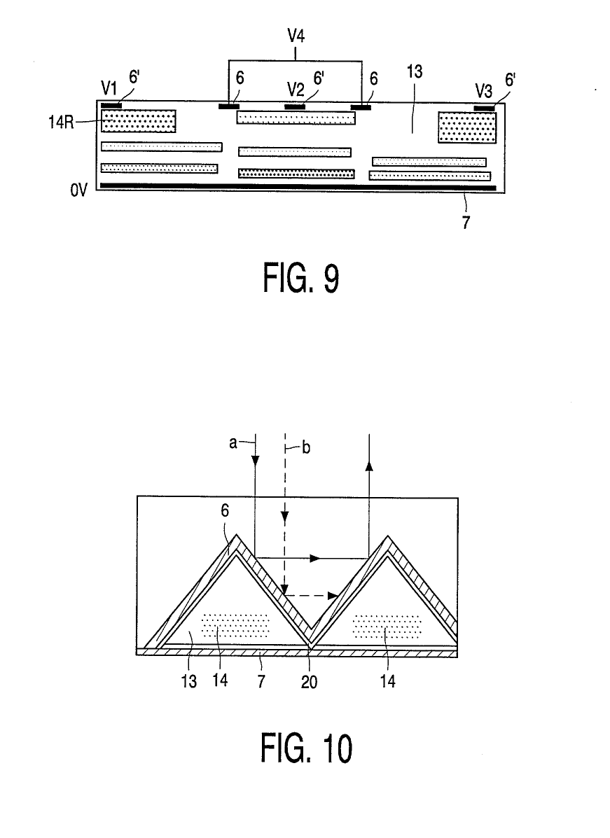

FIG. 9 is a cross-section taken on the line IX-IX in FIG. 8,

FIG. 10 shows another electrophoretic color display device according to the invention, while

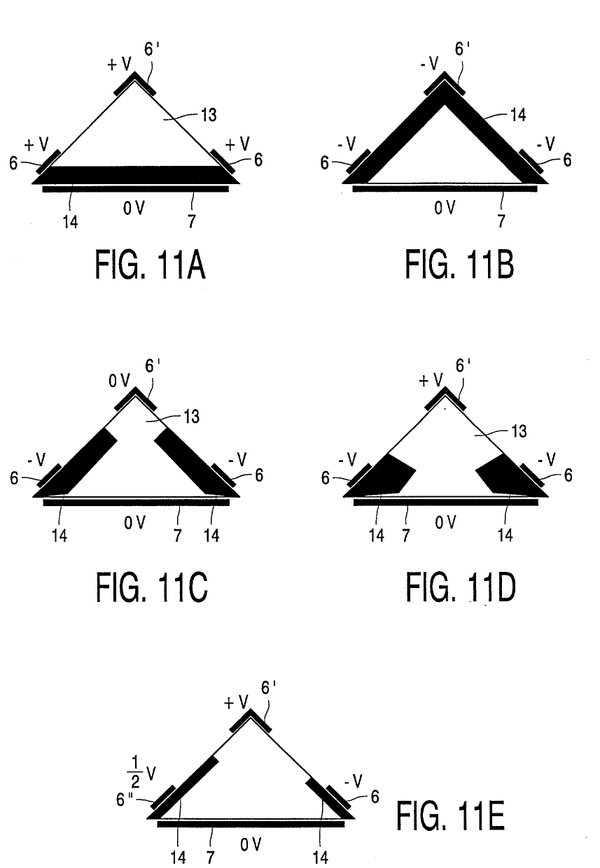

FIG. 11 shows how different grey values (intermediate optical states) have been realized in the display device shown in FIG. 10.

The Figures are diagrammatic and not drawn to scale. Corresponding components are generally denoted by the same reference numerals.

FIG. 1 shows an electrical equivalent of a part of a color display device 1 to which the invention is applicable. It comprises a matrix of pixels 3 at the area of crossings of row or selection electrodes 7 and column or data electrodes 6. The row electrodes 1 to m are consecutively selected by means of a row driver 4, while the column electrodes 1 to n are provided with data via a data register 5. In this example, the pixels in columns 1, 4, 7, . . . , n−2constitute red pixels, the pixels in columns 2, 5, 8, . . . , n−1 constitute blue pixels, and the pixels in columns 3, 6, 9, . . . , n constitute green pixels. To this end, incoming data 2 are first processed, if necessary, in a processor 10. Mutual synchronization between the row driver 4 and the data register 5 takes place via drive lines 8.

Drive signals from the row driver 4 and the data register 5 select a pixel 10 (referred to as passive drive). In known devices, a column electrode 6 receives such a voltage with respect to a row electrode 7 that the pixel at the area of the crossing is in at least one of two extreme states (for example, black or colored, dependent on the colors of the liquid and the electrophoretic particles).

If desired, drive signals from the row driver 4 can select the picture electrodes via thin-film transistors (TFTs) 9 which have their gate electrodes electrically connected to the row electrodes 7 and their source electrodes 21 to the column electrodes 6 (referred to as active drive). The signal at the column electrode 6 is transferred via the TFT to a picture electrode of a pixel 10, coupled to the drain electrode. The other picture electrodes of the pixel 10 are connected to, for example, ground by means of, for example, one (or more) common counter electrode or electrodes. In the example of FIG. 1, such a TFT 9 is shown diagrammatically for only one pixel 10.

In a first color display device according to the invention, each pixel is provided with a further electrode and drive means for supplying the further electrode with electric voltages. This is shown in FIG. 2, which is a cross-section of such a pixel provided with a third electrode 6′. The drive means comprise, for example, the data register 5 (and possibly a part of the driver), and extra column electrodes 6′ (and an extra TFT in the case of active drive).

A pixel 10 (FIG. 2) comprises a first substrate 11 of, for example, glass or a synthetic material, provided with a switching electrode 7, and a second transparent substrate 12 provided with a switching electrode 6. The pixel is filled with an electrophoretic medium, for example, a white liquid 13 in which particles 14 are present, in this example colored, positively charged particles 14. Furthermore, the pixel is provided with a third electrode 6′ (and, as described hereinbefore, if necessary with drive means which are not shown in FIG. 2) for realizing intermediate optical states via electric voltages on the third electrode. In this respect it is to be noted that the third electrode 6′ also influences the switching behavior between the two extreme states.

In FIG. 2A, for example, the switching electrode 7 is connected to ground, while both electrodes 6, 6′ are connected to a voltage +V. The particles 14 (which are positively charged in this example) move towards the electrode at the lowest potential, in this case the electrode 7. Viewed from the viewing direction 15, the pixel now has the color of the liquid 13 (white in this case). In FIG. 2B, the switching electrode 7 is connected to ground, while both electrodes 6, 6′ are connected to a voltage −V. The positively charged particles 14 move towards the lowest potential, in this case towards the potential plane defined by the electrodes 6, 6′, parallel to and just along the substrate 12. Viewed from the viewing direction 15, the pixel now has the color of the particles 14.

The switching electrode 7 is also connected to ground in FIG. 2C. The electrode 6 is connected to a voltage −V again. Now, however, the third electrode 6′ is connected to ground, similarly as electrode 7. The positively charged particles 14 move towards the lowest potential, in this case an area around electrodes 6. This is even more strongly the case if the third electrode 6′ is connected to a voltage +V, as is shown in FIG. 2D. Viewed from the viewing direction 15, the pixel now only partly has the color of the particles 14 and partly the color of the white liquid. This results in an intermediate reflection level (grey value) (dark in the case of FIG. 2C and light in the case of FIG. 2D).

Since the particles do not always remain positioned on the substrate, for example, due to motion in the liquid, it may be advantageous to provide the substrate with a sticking layer.

When black particles are chosen for the particles 14, a color display device is obtained by forming the (sub-)pixels, for example, as shown in FIG. 2 and by providing the whole with a color filter 16 as is shown in FIG. 3. The columns 1, 4, 7, . . . , n−2 are then covered (see FIG. 3) with red color filter portions 16R, the columns 2, 5, 8, . . . , n−1 are covered with blue color filter portions 16B and the columns 3, 6, 9, . . . , n are covered with green color filter portions 16G. Otherwise, the reference numerals in FIG. 3 denote the same components as in FIG. 2.

The color filter may be omitted when, as shown in FIG. 4 for the particles 14, particles of the desired color are used in each column, namely red particles 14R for the red (sub-)pixels, blue particles 14B for the blue (sub-)pixels and green particles 14G for the green (sub-)pixels.

A possibility of limiting the motion of liquid is the use of microcapsules as described in “Micro Encapsulated Electrophoretic Materials for Electronic Paper Displays”, 20^{th} IDRC Conference, pp. 84-87 (2000). The electrophoretic medium, a liquid 13 with positively charged particles 14 is now present in microcapsules 17 in a transparent substrate 18 (see FIG. 5).

In the Figure, the switching electrode 7 is again connected to ground (0 V), while, in this example, the electrodes 6, 6′ are connected to a voltage −V and ground (0 V), respectively. The positively charged (black) particles 14 move towards the lowest potential, in this case in the direction of electrode 6 and are ultimately present for the greater part in the upper part of the microcapsule 17. Viewed from the viewing direction 15, the pixel now has an intermediate color (dark grey for black particles).

Similarly as described with reference to FIGS. 3 and 4, a color display device can be obtained by applying black particles and a white liquid in all microcapsules and by providing the display device with a color filter (diagrammatically denoted by means of the broken line 16 in FIG. 5).

Preferably, however, each microcapsule 17 is coupled to one color, as shown in FIG. 5, by mixing a suitable liquid with red particles 14R, blue particles 14B and green particles 14G, respectively. Further reference numerals in FIG. 3 are identical to those in the other Figures.

FIG. 6 shows a color display device as described in U.S. Pat. No. 6,017,584. A pixel is filled again with an electrophoretic medium, for example, a white liquid 13 comprising particles 14, colored, positively charged particles 14 in this example, consisting of red particles 14R, green particles 14G and blue particles 14B. The particles do not only have a different color but also a difference of mobility. For example, the red particles move faster in an electric field than the green ones and these, in turn, move faster than the blue ones.

In the situation of FIG. 6A, all particles are present near the electrode 7 (which has a potential 0, while electrode 6 has a potential +V). The pixel then has a white appearance. In FIG. 6B, the electrode 6 receives a negative pulse (square-wave voltage) 20 with amplitude −V which lasts sufficiently long to cause all of the red particles 14R to move towards the electrode 6. Consequently, the pixel now has a red appearance. The green particles 14G have covered, for example, half the distance (preferably slightly more) between the electrodes 6 and 7. When using a negative pulse (square-wave voltage) 20 having a double duration, these particles will also reach the electrode 6. By subsequently presenting a short positive pulse (square-wave voltage) 21 (FIG. 6C), the red particles 14R again move in the direction of the electrode 7 and only green particles 14G are present at the area of the electrode 6. The pixel now has a green appearance. By giving the (sub-)square-wave voltages 20, 21 an even longer duration, it is achieved that only blue particles 14B are present at the area of the electrode 6 (FIG. 6D) and the pixel gets a blue appearance.

In the display device of FIG. 7, three such pixels are shown which are each provided with a third electrode 6′ conveying voltages of 0 V, −V and +V, respectively, and described similarly as with reference to FIG. 2. By providing electrode 6 again with similar pulse patterns, as described with reference to FIG. 6, the particles 14 move towards the electrode 6 in a different way due to the difference of mobility, so that different transmission values are possible for each color. It is thereby achieved that particles of only one color are simultaneously visible, which leads to brighter colors (more color saturation).

It is also possible to provide electrode 6 with pulse patterns. Mixing of particles of different colors can thereby be obtained on the visible surface. It is therefore not always necessary, as in U.S. Pat. No. 6,017,584, to impose the requirement on the particles 14 that they should not overlap one another as far as their (mobility) properties are concerned. Dependent on the (extent of overlap of the) (mobility) properties, the desired color variations can be obtained by varying the pulse patterns 20, 21.

The color display devices of FIG. 8 comprise several electrodes 6, 6′ on one and the same substrate. In this example, the switching electrodes 6, 6′ are connected to four voltage sources (configurations A, B, C) or five voltage sources (configuration D) which supply pulse patterns. By suitably manipulating the different voltages, colors having different transmission values can be generated again on different parts of the upper surface, as is shown in FIG. 9 by way of example for configuration B. The reference numerals in FIG. 9 have the same significance as those in the other Figures. An advantage of the embodiment shown in FIG. 9 is that it comprises two electrodes 6, 6′ less per color triplet.

The electrophoretic medium may also be present in a prismatic structure, as described in “New Reflective Display Based on Total Internal Reflection in Prismatic Microstructures” Proc. 20^{th} IDRC Conference, pp. 311-314 (2000). This is shown in FIGS. 10, 11. The known device (FIG. 10) comprises a prismatic structure of (in this example) a repetitive structure of hollow (for example, glass) triangles comprising a liquid 13 containing positively charged particles.

Dependent on the voltages across the electrodes 6, 7, the positively charged particles are present on the (bottom) electrode 7 of metal or on the ITO (top) electrode 6. In the first-mentioned case, an incident beam is totally reflected on the glass-liquid interfaces and is reflected (arrow a). In the second case, an incident beam is absorbed on the glass-liquid interfaces (arrow b).

By introducing a third electrode 6′ again, various electrical field configurations can be introduced, similarly as in the examples of FIGS. 2 and 4, with different intermediate reflection values (grey values). When using black positively charged particles 14 in a white liquid 13, the configurations of FIGS. 11A, 11B, 11C, 11D and 11E correspond to the colors white, black, dark grey and light grey and an intermediate tint.

Colors can be obtained again by means of color filters, or in a manner similarly as described with reference to the previous examples.

The invention is of course not limited to the examples described hereinbefore. For example, the examples described hereinbefore always refer to red, green and blue colors for the sub-pixels, whereas eminent results can also be obtained with the colors yellow, cyan and magenta, while a fourth (for example, black) element can be added. The invention is also applicable to display devices with two colors (monochrome, for example, black and white).

The color patterns do not need to be provided as stripes; notably, zigzag patterns may be used alternatively. The shape of the prismatic structure of FIG. 10 may also be varied in several ways, such as roof-shaped, spherical or cylindrical.

If necessary, the substrate 12 may be provided with an extra (transparent) electrode, for example, for the above-mentioned reset function or, in contrast, for limiting the motion of the particles 14 in the direction of the substrate 12. A combination of one or more of said possibilities is alternatively applicable in practice.

The protective scope of the invention is not limited to the embodiments described.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such element.

1. An electrophoretic multi-color display device comprising at least a pixel with an electrophoretic medium, and two switching electrodes and drive means via which the pixel can be brought to different optical states, the pixel being provided with at least one further electrode and drive means for realizing intermediate optical states via electric voltages.

2. An electrophoretic color display device as claimed in claim 1, wherein the color display device comprises means for bringing the pixel to a defined state prior to selection.

3. An electrophoretic color display device as claimed in claim 1, wherein a pixel comprises at least two further electrodes and drive means for realizing intermediate optical states via electric voltages.

4. An electrophoretic color display device as claimed in claim 1 or 3, wherein the electrophoretic medium is present between two substrates which are each provided with a switching electrode, and at least one of the substrates is provided with the further electrode or electrodes.

5. An electrophoretic color display device as claimed in claim 1 or 3, wherein the electrophoretic medium is present in a microcapsule.

6. An electrophoretic color display device as claimed in claim 5, with one microcapsule per pixel or with one microcapsule per sub-pixel.

7. An electrophoretic color display device as claimed in claim 1 or 3, wherein the electrophoretic medium is present between two substrates, in which one of the substrates comprises the switching electrodes and the further electrode or electrodes.

8. An electrophoretic color display device as claimed in claim 7, wherein the switching electrodes are comb-shaped and interdigital, and parts of the further electrode or further electrodes are located between the teeth of the two switching electrodes.

9. An electrophoretic color display device as claimed in claim 1 or 3, wherein the electrophoretic medium is present in a prismatic structure.

10. An electrophoretic color display device as claimed in claim 1 or 3, with at least three types of particles, in which the mobilities of different types of particles are partly within an overlapping range.

11. An electrophoretic color display device as claimed in claim 1 or 3, with at least three types of particles, in which the mobilities of different types of particles are within substantially non-overlapping ranges.

12. An electrophoretic color display device as claimed in claim 11, wherein the drive means for different colors to be displayed present different pulse patterns to the further electrodes.

13. An electrophoretic color display device as claimed in claim 1 or 3, provided with a color filter.

14. An electrophoretic display device comprising at least a pixel with an electrophoretic medium, and two switching electrodes and drive means via which the pixel can be brought to different optical states, the pixel being provided with at least one further electrode and drive means for realizing intermediate optical states via electric voltages.
